(19) United States
(12) Patent Application Publication
(10) Pub. No.: US 2022/0115787 A1
(43) Pub. Date: Apr. 14, 2022

(54) Electromagnetic Coupling Device For Saving Energy, and Wireless Communication System Comprising Same

(71) Applicants: ZN Technologies Co., Ltd., Ulsan (KR); ZN Ocean Co., Ltd., Busan (KR)

(72) Inventors: Eun Gyu Bae, Gyeonggi-do (KR); Dae Heon Hur, Gyeonggi-do (KR); Chang Soo Kang, Gyeonggi-do (KR); Chul Gyun Park, Seoul (KR)

(21) Appl. No.: 17/309,445

(22) PCT Filed: Nov. 29, 2019
(86) PCT No.: PCT/KR2019/016688

§ 371 Date: May 27, 2021

(30) Foreign Application Priority Data
Nov. 29, 2018 (KR) 10-2018-0151384
Oct. 10, 2019 (KR) 10-2019-0125322

(51) Int. Cl. H01Q 9/04

(52) U.S. Cl. CPC H01Q 9/0457

(57) ABSTRACT

An electromagnetic coupling device and a wireless communication system comprising same are disclosed. One embodiment comprises: an antenna part having an impedance component; and an attachment part which attaches an electromagnetic coupling device to a conductor such that a certain interval is formed between the antenna part and the conductor, and which forms a capacitance between the antenna part and the conductor.

### TECHNICAL FIELD

Example embodiments relate to an electromagnetic coupling device and a wireless communication system including the electromagnetic coupling device.

### BACKGROUND ART

A general communication antenna tends to have a reduced resonance characteristic and electromagnetic coupling characteristic when it is disposed on the surface of a metal such as iron or being in contact with the surface of the metal. Thus, in a closed environment surrounded by metals such as a container box and a large ship, there may be a technical difficulty in establishing communication between an antenna disposed inside and an antenna disposed outside.

Thus, there is a desire for new research on a method and device for unconstrainedly transmitting electromagnetic waves and performing data communication even in a closed environment surrounded by metals.

Korean Registration No. 10-1475476 (registered date 2014. 12. 16) discloses a communication method and system in a ship, which relates to a method of communicating in a ship using a wired terminal and a wireless terminal in a combined manner.

### DISCLOSURE OF INVENTION

### Technical Solutions

According to an example embodiment, there is provided an electromagnetic coupling device including an antenna part having an inductance component, and an attachment part configured to attach the electromagnetic coupling device to a conductor such that a predetermined interval is formed between the antenna part and the conductor and that capacitance is formed between the antenna part and the conductor.

A frequency-based impedance Z of the antenna part attached to the conductor may be formed inside or outside the antenna part, and resonance may thus be formed in the antenna part and the conductor. Here, Z=R+jX.

As the resonance occurs, the conductor and the antenna part may be electromagnetically coupled with each other, and the conductor may perform a function as a portion of an antenna.

The antenna part may include a first layer formed of a conductive material and including at least one opening facing the conductor, a second layer formed of a conductive material and disposed adjacent to the first layer, and a third layer formed of a dielectric material and disposed between the first layer and the second layer.

The electromagnetic coupling device may further include an impedance matching circuit configured to adjust an impedance that changes by a metal of various materials between the antenna part and the conductor or by a metal surface under various conditions to allow the resonance to occur between the antenna part and the conductor.

According to another example embodiment, there is provided a wireless communication system including a communication device configured to generate information to be transmitted or process received information based on input information, and an electromagnetic coupling device configured to be connected to the communication device.

The electromagnetic coupling device may include an antenna part having an inductance component, and an attachment part configured to attach the electromagnetic coupling device to a conductor such that a predetermined interval is formed between the antenna part and the conductor and that capacitance is formed between the antenna part and the conductor.

Resonance may be formed in the antenna part and the conductor.

As the resonance is formed, the conductor and the antenna part may be electromagnetically coupled, and the conductor may perform a function as a portion of an antenna.

The antenna part may include a first layer formed of a conductive material and including at least one opening facing the conductor, a second layer formed of a conductive material and disposed adjacent to the first layer, and a third layer formed of a dielectric material and disposed between the first layer and the second layer.

The electromagnetic coupling device may further include an impedance matching circuit configured to adjust an impedance that changes by a metal of various materials between the antenna part and the conductor or by a metal surface under various conditions to allow the resonance to occur between the antenna part and the conductor.

### Advantageous Effects

According to an example embodiment described herein, using a metal surface as a portion of an antenna to overcome an issue of attenuation of the metal surface, it is possible to reduce the size of the antenna by the size of the metal surface used, and enable smooth wireless communication even in a complex metal structure, for example, a ship.

In addition, according to an example embodiment described herein, by enabling wireless communication in a complex metal structure, it is possible to reduce the cost used for an existing communication cable and the time used for an installation construction of the communication cable, reduce production energy for required additional facilities and raw materials, reduce the weight of the communication cable which reaches a few tons, and reduce an amount of use of fuel required for a ship operation. Thus, it is possible to save a considerable amount of energy for a ship operation period of approximately 20 years and reduce air pollution, thereby contributing to environmental friendliness.

### BRIEF DESCRIPTION OF DRAWINGS

FIGS. 1 and 2 are diagrams illustrating an example of an electromagnetic coupling device according to an example embodiment.

FIGS. 3 through 5 are diagrams illustrating an example of an antenna part in an electromagnetic coupling device according to an example embodiment.

FIG. 6 is a diagram illustrating an example of a wireless communication system according to an example embodiment.

FIG. 7 is a diagram illustrating an example to which a wireless communication system is applied according to an example embodiment.

### BEST MODE FOR CARRYING OUT THE INVENTION

Hereinafter, some examples will be described in detail with reference to the accompanying drawings.

However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

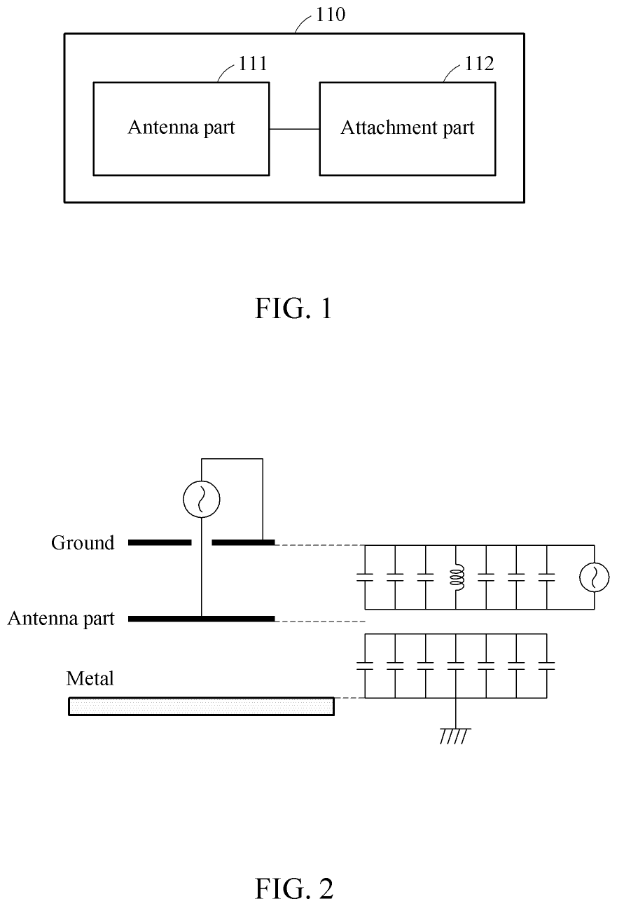

FIGS. 1 and 2 are diagrams illustrating an example of an electromagnetic coupling device according to an example embodiment.

Referring to FIG. 1, an electromagnetic coupling device 110 includes an antenna part 111 and an attachment part 112.

The antenna part 111 may have an impedance component. The impedance component may include, for example, a small amount of a resistance component, an inductance component, and/or a capacitance component.

The attachment part 112 may attach the electromagnetic coupling device 110 to a conductor. For example, the attachment part 112 may include a magnet, and attach the electromagnetic coupling device 110 to the surface of the conductor through the magnet.

The attachment part 112 may attach the electromagnetic coupling device 110 to the conductor such that a predetermined interval is formed between the antenna part 111 and the conductor. For example, the electromagnetic coupling device 110 may be attached to the conductor with the interval between the antenna part 111 and the conductor such that the antenna part 111 and the conductor (or the surface of the conductor) are coupled with each other by a suitable capacitance component. Thus, resonance may be formed in the antenna part 111 and the conductor. That is, an impedance Z of the antenna part 111 that depends on a frequency associated with the electromagnetic coupling device 110 attached to the conductor may be formed inside or outside the antenna part 111, and the resonance may thus be formed in the antenna part 111 and the conductor. Here, Z=R+jX, in which R denotes a resistance component and X denotes a reactance component.

The conductor in which the resonance is formed along with the antenna part 111 may operate as a portion of an antenna.

According to an example embodiment, a metal surface may be used as a portion of an antenna to overcome an existing issue of attenuation of a complex metal surface of an antenna and the size of the antenna may thus be reduced by the size of the metal surface used, and smooth wireless communication may be enabled even in a complex metal structure, for example, a ship. In addition, according to an example embodiment, wireless communication may be enabled in a complex metal structure, and it is thus possible to reduce the cost used for an existing communication cable and the time used for an installation construction of the communication cable, reduce production energy for required additional facilities and raw materials, reduce the weight of the communication cable which reaches a few tons, and reduce an amount of use of fuel required for a ship operation. Thus, it is possible to save a considerable amount of energy for a ship operation period of approximately 20 years and reduce air pollution, thereby contributing to environmental friendliness.

FIG. 2 is a diagram illustrating an example of an equivalent circuit of the antenna part 111 and a conductor.

Referring to FIG. 2, the antenna part 111 is separated from the surface of a conductor by a predetermined interval. Except, the electromagnetic coupling device 110 may be in a state of being attached to the surface of the conductor.

The antenna part 111 or the electromagnetic coupling device 110 may be reduced in size until there is a capacitance component at a frequency (or an operating frequency) desired to be designed while the electromagnetic coupling device 110 is attached to the surface of the conductor. That is, the size of the antenna part 111 (or the electromagnetic coupling device 110) may be reduced until the capacitance component becomes exhibited while attached to a metal surface with a predetermined interval therebetween. In other words, the antenna part 111 (or the electromagnetic coupling device 110) may be reduced in size until there is the capacitance component between the antenna part 111 and the surface of a metal.

An inductance component that is resonant with the capacitance component adjusted by the size reduction while the electromagnetic coupling device 110 is attached to the surface of the metal may be designed or included in the antenna part 111. As the antenna part 111 has the inductance component, it may be electromagnetically coupled with the metal surface, and the resonance may thereby be formed in the antenna part 111 and the metal. That is, the inductance component may be added to the antenna part 111 such that the antenna part 111 reduced in size is coupled with the metal surface through resonance.

According to an example embodiment, the electromagnetic coupling device 110 may include an impedance matching circuit.

The impedance matching circuit may adjust the capacitance component based on an environmental change between the antenna part 111 and the metal. For example, the impedance matching circuit may adjust a change in an impedance by a distance between the antenna part 111 and the metal and an electrical characteristic of paint.

In addition, the impedance matching circuit may automatically adjust the impedance that changes by a metal of various materials or a metal surface under various conditions.

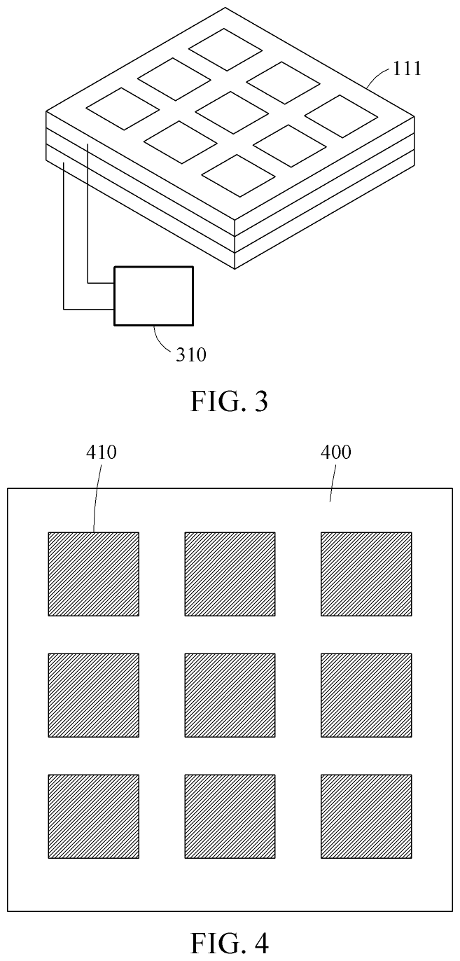

FIGS. 3 through 5 are diagrams illustrating an example of an antenna part in an electromagnetic coupling device according to an example embodiment.

Referring to FIG. 3, the antenna part 111 includes a plurality of layers. For example, the antenna part 111 may include a first layer of a conductive material that includes an opening and faces a metal medium, a second layer of a conductive material disposed on an opposite side to the first layer, and a third layer of a dielectric material that is included between the first layer and the second layer.

Referring also to FIG. 4, illustrated is a plan view of the antenna part 111. For a non-limiting example, the first layer and/or the second layer may include nine openings 410 which are arranged in a form of a 3x3 arrangement. However, the number of openings may be determined differently based on an application or a communication environment. Thus, the first layer and the second layer may have a single opening surface or a plurality of opening surfaces, but not have an opening surface as needed. The shape of an opening surface may be circular or polygonal, and the size thereof may be determined such that a magnetic field-dominant electromagnetic field is formed in a metal medium and sufficient energy is thus transferred.

To the first layer or the second layer, another layer(s) with a different electrical characteristic may be added in an opposite direction to the third layer. For example, a different dielectric layer may be added onto the first layer to induce the formation of a strong electromagnetic field. For another example, a nonconductor may be added onto the first layer to prevent an electrical connection to the metal medium.

The third layer which is an intermediate layer between the first layer and the second layer may be formed with a dielectric or a nonconductor. The third layer may include, as a non-limiting example, at least one material among carbon fiber, acrylic, and polycarbonate. The third layer may also another material, for example, paint, paper, polymer film, and the like. In addition, the third may include a plurality of layers with different characteristics, for example, a plurality of dielectrics or nonconductors. An example having two or more dielectric layers is illustrated in FIG. 5. FIG. 5 is a side view of the antenna part 111 according to another example embodiment. Referring to FIG. 5, dielectric layers 520 and 540 may be arranged between conductive layers 510, 530, and 550 such as, for example, copper.

Referring back to FIG. 3, a transmitting and receiving circuit part 310 may be a circuit device configured to convert a signal transmitted from or received by the antenna part 111 to a significant signal. The transmitting and receiving circuit part 310 may be divided into a transmitting circuit and a receiving circuit. The transmitting and receiving circuit part 310 may include a power supply circuit for supplying sufficient power to the antenna part 111 and a battery therefor. Although the transmitting and receiving circuit part 310 has a similar structure to that of a general transmitting system for wireless communication, it may additionally need a circuit for sufficient power for the electromagnetic coupling of the antenna part 111 in some cases. For example, the transmitting and receiving circuit part 310 may include a power amp, an automatic gain controller (AGC), and the like.

The transmitting and receiving circuit part 310 may be implemented in a communication device to be described hereinafter, but not limited thereto.

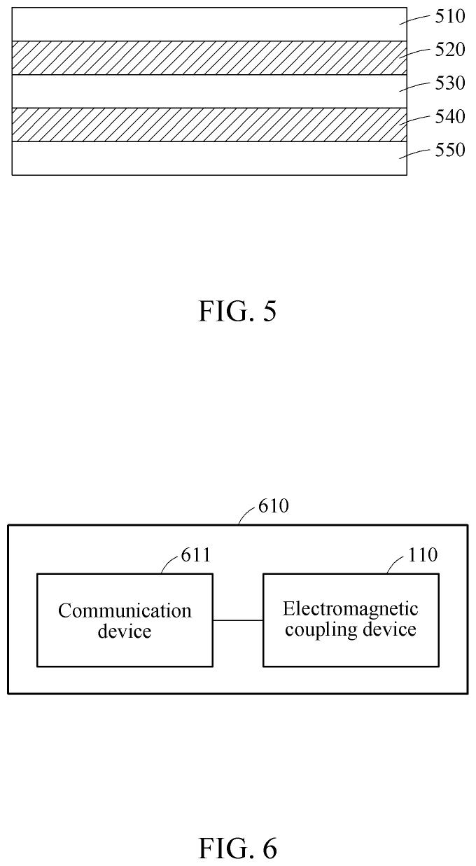

FIG. 6 is a diagram illustrating an example of a wireless communication system according to an example embodiment.

Referring to FIG. 6, a wireless communication system 610 includes a communication device 611 and the electromagnetic coupling device 110.

The communication device 611 may generate transmission information that is to be transmitted or process reception information that is received, based on input information. The communication device 611 may be mobile. For example, the communication device 611 may be a radio or wireless transceiver or a mobile interphone, but examples of which are not limited thereto. According to implementation, the communication device 611 may be stationary.

The electromagnetic coupling device 110 may be connected to the communication device 611. Thus, the transmission information generated by the communication device 611 may be transmitted to the electromagnetic coupling device 110, and the electromagnetic coupling device 110 may transmit the transmission information to another electromagnetic coupling device or another wireless communication system through a conductor. In addition, the reception information received by the electromagnetic coupling device 110 may be transmitted to the communication device 611, and the communication device 611 may process the reception information and output a result of the processing. For example, the communication device 611 may output a speech signal.

The antenna part 111 in the electromagnetic coupling device 110 may form resonance with the conductor, and the conductor may perform a function as a portion of an antenna.

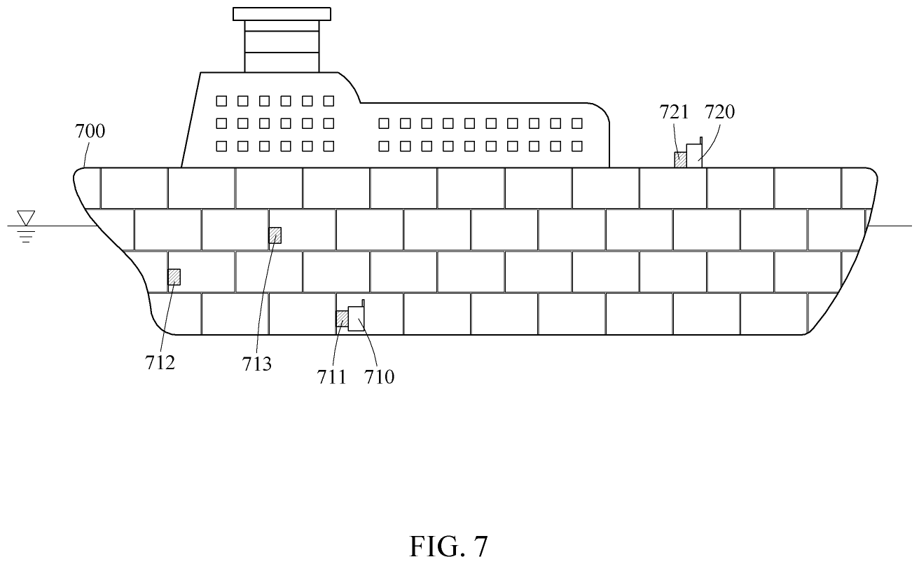

FIG. 7 is a diagram illustrating an example to which a wireless communication system is applied according to an example embodiment.

Referring to FIG. 7, the wireless communication system 610 may be applied to a ship 700.

Referring to FIG. 7, a plurality of electromagnetic coupling devices 711, 712, 713, and 721 may be attached to a plurality of spaces in a plurality of layers. In addition, a first communication device 710 may be connected to the electromagnetic coupling device 711, and a second communication device 720 may be connected to the electromagnetic coupling device 721.

For example, in a case in which the communication devices 710 and 720 are used, communication may be enabled when the electromagnetic coupling devices 711 through 721 are connected by a metal or even when they are not connected by a metal. The electromagnetic coupling devices 711 through 721 may be connected by an iron wall or bulkhead, and thus communication may be enabled without an additional wired connection. That is, communication between the communication device 710 and the communication device 720 may be enabled. In addition, the electromagnetic coupling devices 712 and 713 at different positions may be connected up to the electromagnetic coupling device 721 at a different position through the iron wall, and communication may be enabled without an additional wired connection, and thus the communication device 710 may communicate with the communication device 720 even at a position to which the communication device 710 moves. In the example illustrated in FIG. 7, the communication device 710 may communicate with the communication device 720 attached to the electromagnetic coupling device 721, even when it is attached to the electromagnetic coupling device 712 or the electromagnetic coupling device 713.

Although electromagnetic coupling devices are illustrated as being attached to certain positions in the example, the positions are not limited thereto, and wireless communication between the communication devices 710 and 720 attached to the ship 700 may be enabled when a metal body is connected or even when there is no connection by a metal. Thus, without the positions being fixed, the electromagnetic coupling devices may be attached to a portable wireless communication device such as a radio transceiver to be used in motion as needed. For example, a radio transceiver of a worker (or a user) inside an iron wall or bulkhead may transmit a signal to the electromagnetic coupling device 110. When the electromagnetic coupling device 110 receives the signal, the iron wall that forms resonance with the antenna part 111 in the electromagnetic coupling device 110 may perform a function as a portion of a transmitting antenna, and thus the signal of the radio transceiver may be transmitted to another wireless communication system through the iron wall. The iron wall may also perform a function as a portion of a receiving antenna to receive a signal from the other wireless communication system, and the electromagnetic coupling device 110 may transmit the signal to the radio transceiver inside the iron wall.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An electromagnetic coupling device comprising:
an antenna part having an inductance component; and
an attachment part configured to attach the electromagnetic coupling device to a conductor such that a predetermined interval is formed between the antenna part and the conductor and that capacitance is formed between the antenna part and the conductor.

2. The electromagnetic coupling device of claim 1, wherein resonance occurs in the antenna part and the conductor.

3. The electromagnetic coupling device of claim 2, wherein, as the resonance occurs, the conductor is configured to perform a function as a portion of an antenna.

4. The electromagnetic coupling device of claim 1, wherein the antenna part comprises:
a first layer formed of a conductive material and comprising at least one opening facing the conductor;
a second layer formed of a conductive material and disposed adjacent to the first layer; and
a third layer formed of a dielectric material and disposed between the first layer and the second layer.

5. The electromagnetic coupling device of claim 1, further comprising:
an impedance matching circuit configured to adjust an impedance that changes by a metal of various materials between the antenna part and the conductor or by a metal surface under various conditions to allow resonance to occur between the antenna part and the conductor.

6. A wireless communication system comprising:
a communication device configured to generate information to be transmitted or process received information based on input information; and
an electromagnetic coupling device configured to be connected to the communication device,
wherein the electromagnetic coupling device comprises:
an antenna part having an inductance component; and
an attachment part configured to attach the electromagnetic coupling device to a conductor such that a predetermined interval is formed between the antenna part and the conductor and that capacitance is formed between the antenna part and the conductor.

7. The wireless communication system of claim 6, wherein resonance occurs in the antenna part and the conductor.

8. The wireless communication system of claim 7, wherein, as the resonance occurs, the conductor is configured to perform a function as a portion of an antenna. 15

9. The wireless communication system of claim 6, wherein the antenna part comprises:
a first layer formed of a conductive material and comprising at least one opening facing the conductor;
a second layer formed of a conductive material and disposed adjacent to the first layer; and
a third layer formed of a dielectric material and disposed between the first layer and the second layer.

10. The wireless communication system of claim 6, wherein the electromagnetic coupling device further comprises:
an impedance matching circuit configured to adjust an impedance that changes by a metal of various materials between the antenna part and the conductor or by a metal surface under various conditions to allow resonance to occur between the antenna part and the conductor.
